(19) United States
(12) Patent Application Publication
(10) Pub. No.: US 2012/0296705 A1
(43) Pub. Date: Nov. 22, 2012

(54) Method and System for Managing Network Marketing

(76) Inventors: Michel Bayan, Los Angeles, CA (US); Michael Hunter Gray, Los Angeles, CA (US)

(21) Appl. No.: 13/476,007

(22) Filed: May 20, 2012

Related U.S. Application Data
(60) Provisional application No. 61/488,134, filed on May 19, 2011.

(51) Int. Cl. G06Q 10/06

(52) U.S. Cl. 705/7.42

(57) ABSTRACT

The present inventive subject matter is a method that can receive sales activity data from a plurality of users, calculate metrics based on the sales activity data, the metrics having an indicator that a first user's sales numbers are greater than fifty percent of a predetermined goal followed by a the ability to generate a message to be sent to a second user with the message configured to inform the second user regarding the progress of the first user's sales activities; the message incorporates a link that is selected by the second user to send a message back to the first user.

### CROSS-REFERENCE TO RELATED PATENT APPLICATIONS

This application claims the benefit of U.S. Provisional Patent Application No. 61/488,134, filed May 19, 2011, which is incorporated herein by reference in its entirety herein.

### BACKGROUND

The aspects of the disclosure relate generally to the field of network marketing. In particular, features of the system and method are directed to allow the individuals involved in the network marketing activities to access data regarding their performance and their team's performance in a format to encourage revenue generation activities. The system determines and displays information to the individuals that is most likely to lead to productive, revenue generating activity. The information is customized based on each individual's situation. Moreover, the systems informs the individual regarding actions that the team members should take to achieve their goals.

### SUMMARY

One of the objects of this invention is a method with the steps of receiving sales activity data from a plurality of users, calculating metrics based on the sales activity data, the metrics including an indication that a first user's sales numbers are greater than fifty percent of a predetermined goal, generating a message to be sent to a second user, where the message is configured to inform the second user regarding the progress of the first user's sales activities, and the message comprises a link that is selectable by the second user to send a message to the first user. This method further has the steps of the message informing the first user of their progress towards the goal and the message is configured to include another message by the second user. This method also has the steps of generating a list of actions that the first user can take in order to reach predetermined goal. The method also has the steps of allowing the first user to indicate the chosen action and performing the chosen action on a server and sending a message back to the second user. The method also has the steps where after receiving the choice by the first user, informing the second user regarding the option selected by the first user. The method also has the steps where a report is configured to display a list of users that have been scheduled to be cancelled.

Another of the object of this invention is a apparatus that is a non-transitory computer readable medium storing computer program product, which, when executed by a computer, causes the computer to perform steps of receiving sales activity data from a plurality of users, calculating metrics based on the sales activity data, the metrics including an indication that a first user's sales numbers are greater than fifty percent of a predetermined goal, then generating a message to be sent to a second user, the message configured to inform the second user regarding the progress of the first user's sales activities, and the message comprises a link that is selectable by the second user to send a message to the first user. This apparatus also has the ability to generate the message informing the first user of their progress towards the goal and the message is configured to include another message by the second user. This apparatus also has the ability to generate a list of actions that the first user can take in order to achieve the predetermined goal. This apparatus also has the ability to allow the first user to indicate the chosen action and performing the chosen action on a server and sending a message back to the second user. This apparatus also has the ability to receive the choice by the first user, and information the second user regarding the option selected by the first user. This apparatus also has the ability to generate a report that is configured to display a list of users that have been scheduled to be cancelled.

Another of the object of this invention is a apparatus having a sales database configured to receive sales activity data from a plurality of users; a report generator configured to calculate metrics based on the sales activity data, the metrics including an indication that a first user's sales numbers are greater than fifty percent of a predetermined goal, a user interface generation logic configured to generate a message to be sent to a second user, the message configured to inform the second user regarding the progress of the first user's sales activities, and where the message comprises a link that is selectable by the second user to send a message to the first user. This apparatus also has the ability to configure the message to inform the first user of their progress towards the goal and the message is configured to include another message by the second user. This apparatus also has report configuration logic that is configured to generate a list of actions that the first user can take in order to achieve the predetermined goal. This apparatus also has the ability to allow the first user to indicate the chosen action and performing the chosen action on a server and sending a message back to the second user. This apparatus also has the capability where after receiving the choice by the first user, it informs the second user regarding the option selected by the first user. This apparatus further has the ability to generate a report that is configured to display a list of users that have been scheduled to be cancelled and allowing the second user to contact the list of users that have been scheduled to be cancelled.

These and other embodiments are described in more detail in the following detailed descriptions and the figures. The foregoing is not intended to be an exhaustive list of embodiments and features of the present subject matter. Persons skilled in the art are capable of appreciating other embodiments and features from the following detailed description in conjunction with the drawings.

### BRIEF DESCRIPTION OF THE DRAWINGS

FIG. 1 is a schematic diagram of a data processing system according to an example embodiment.

FIG. 2 is an example process that may be implemented using the system shown in FIG. 1.

FIG. 3 is sequence of displays that may be provided to an account holder using the system shown in FIG. 1 to begin a network marketing management process.

FIG. 4 is a customizable splash screen showing various options that may be presented to a user.

FIG. 5 is a screen display showing account statistics for an example user.

FIG. 6 is a screen display showing a listing of other users who may be about to cancel a service or a subscription.

FIG. 7A is a screen display showing information regarding one of the users listed in FIG. 6.

FIG. 7B is a screen display showing information regarding another user from FIG. 6.

FIG. 8 is a screen display showing a icon display that may be offered to a user that selected the other user's as a favorite user.

FIG. 9 is a screen display screen display showing a listing of other users that have been selected as favorite users.

FIG. 10 is a screen display that may be provided to a users to allow the user to perform a search based on various criteria.

FIG. 11 is screen display that may be provided to an account holder in connection with a second payment program that may be offered to the account holder.

### DETAILED DESCRIPTION OF THE DISCLOSURE

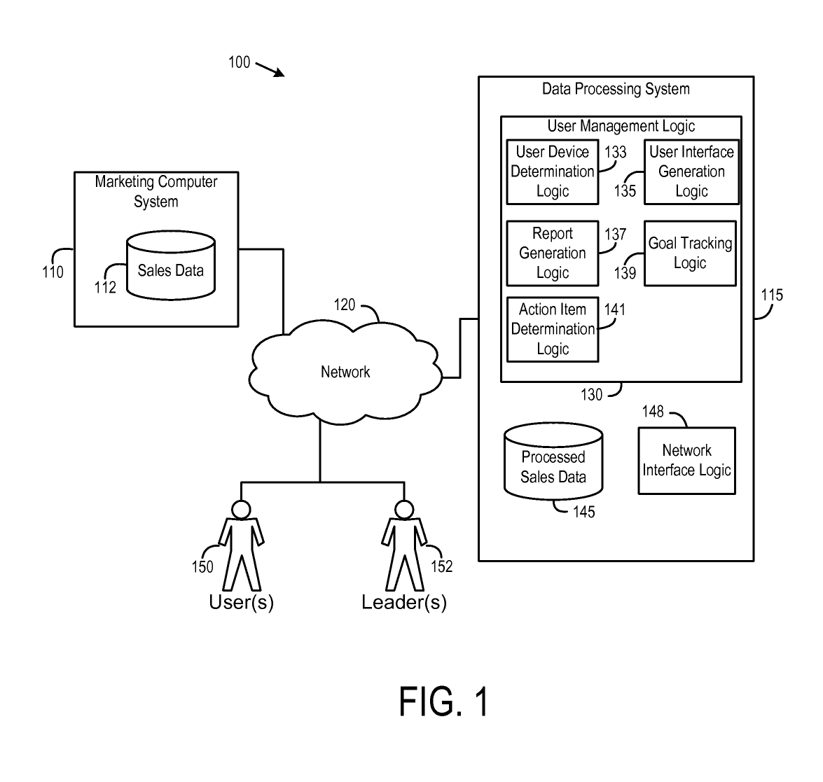

Referring to FIG. 1, a data processing system 100 according to an example embodiment is shown. The data processing system 100 includes a marketing company computer system 110, data processing system 115 or other systems. The marketing computer system 110 may include, among other systems, sales data 112. The data processing server 115 may include, among other systems, user management logic 130, network interface logic 145, and processed sales data 148. The data processing system 115 may further include user device determination logic 133, user interface generation logic 135, report generation logic 137, goal tracking logic 139 and action item determination logic 141.

In an example embodiment, the marketing computer system 110, may be provided by a company that provides services or products to its customers. In another embodiment, the marketing computer system 110 and the data processing system 115 may be provided, owned or controlled by a single company. In yet another embodiment, the marketing computer system 110 and the data processing system 115 may be provided, owned or controlled by two or more companies. In an example embodiment, the users 150 may be contract sales personnel, employees or affiliates of the company or companies that provide the product or services to customer. The users 150 may access the data from the marketing computer system 110 through the data processing system 115, through the Internet, network, or in another manner. The users 150 may access the data in the marketing computer system 110 through an on-line area of a website of the company that owns the marketing computer system 110. In an example embodiment, the users 150 may access the data processing system 115 through a mobile device programmed to receive information from the data processing system 115. As another example, marketing computer system 110 may be associated with other types of companies that maintain sales accounts, such as credit card issuers, mortgage companies, utility companies, insurance companies, product manufacturing company and so on. As another example, part or all of data processing system 100 may be associated with vendors to whom billing, collection, or call center operations are outsourced by other companies.

The marketing computer system 110 may be configured to receive data regarding the sales activities of a plurality of users 150 that may be generating sales. The sales data 112 may be stored in a variety to database formats, i.e. SAP®, Oracle®, SQL Server®, AS400® and so on. The marketing computer system 110 may include other computer systems that monitor sales activity and are configured to inform the decision makers regarding number of items, services or policies sold by each individual for a period of time. The period of time may be weekly, monthly, quarterly, or yearly. The sales data 112 may be shared with the users 150 or 152 via a website provided by the marketing computer system 110 or may be printed and sent to the users 150. In another embodiment, the sales data 112 may be transmitted to the users 150 or 152 via a mobile device with a pocket size display screen.

The user device determination logic 133 may be configured to determine the type of device being used by the users 150 and 152. For example, the users 150 may use a mobile device that is configured to communicate with the data processing system 115. In other embodiments, the users 150 and 152 communicate via a network 120 with the data processing system 115. The device determination logic 133 may be configured to determine the type of device, the type of operating system, and the version of the software that the user's mobile is using. After determination the type of device the user interface presented to the user may be customized by the user interface generation logic 135.

The user interface generation logic 135 may be configured to generate a customized user interface for user 150. The customized user interface may provide the user 150 with personalized sales and goal information data. The user interface generation logic 135 may selectively send data to display to the user 150 on the user's mobile device. The user interface generation logic 135 may receive the selective information from various other logics in the data processing system 115. In another embodiment, the user interface generation logic 135 may select the data based in part on which actions by an example user may generate the most revenue or which actions by the user may help a member of the user's team reach the next goal. The actions may include providing an option to contact a member of the user's teams, contact a customer who is about to cancel the user's services or other selectable options.

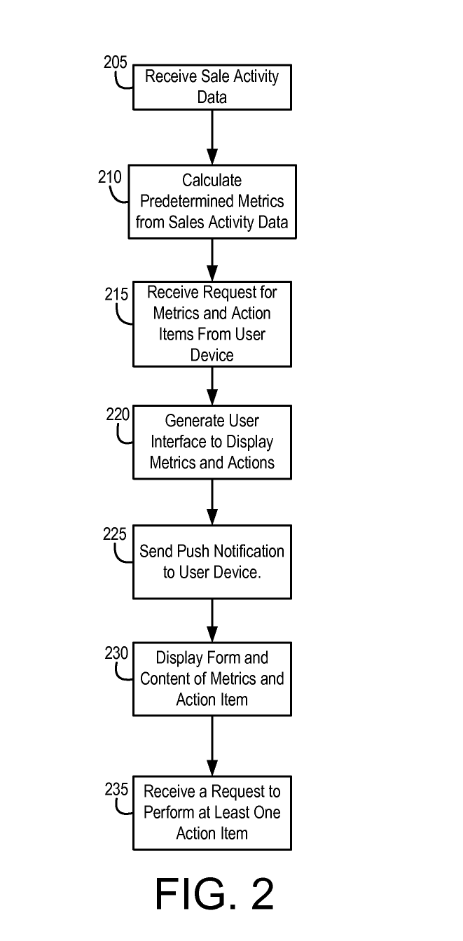

The report generation logic 137 may be configured to receive sales data 112 and generate various customized reports for the users 150. The custom report may include determining the top producers, top recruiters, qualified leads, unqualified leads, pre-cancel orders, and so on. The method of determining at least the above reports is described below with reference to FIG. 2. The report generation logic 137 may process the sales data 112 and store the processed results as processed sales 145.

The goal tracking logic 139 may be configured to receive various goals, promotions that includes a set of actions or tasks a user 150 can perform to achieve a company defined goal. Reaching a goal may allow the user to receive a benefit (i.e. funds, increase in rank, and so on). The goal tracking logic 139 may determine that a user 150 is partially performed the actions of a goal and needs to perform some other actions to complete a goal. If the user 150 has another user as a supervisor, then the supervising user may be presented with a visual display by the user interface generation logic 135 that allows the supervising user to contact the user 150 regarding the proximity to the goal. Other embodiments of the goal tracking logic 139 may allow a supervising user to communicate with the other users using e-mail, telephone, mobile phone, text message.

The action item determination logic 141 may determine which actions are of the highest priority to the users 150. Upon determining which actions are of the highest priority to the user 150. The highest priority option(s) may be displayed to the users. Various different algorithms can be used to determine what should be the highest priority to a user. In another embodiment, the user may specify what actions or results are of the highest priority to the user. In an example embodiment, the action that yields the highest revenue may be considered of the highest priority to the user.

The processed sales data 145 stores user account data and processed sales data. The processed sales data comprises portions of the sales data and additional all the data and reports calculated by the user interface logic 135, report generation logic 137, goal tracking logic 139 and action item determination logic 141. In an example embodiment, the processed sales data 145 may be sent to the mobile devices of the users 150 via a secure connection (i.e. SSW or AES® or other security protocols). In another embodiment, the processed sales data 145 may be served to the user devices such that the user devices are not permitted to store any of the data in the user devices non-volatile memory. In other embodiments, the user device can be configured to store the processed sales data 145 pertaining to the user of the device in the user device memory. In other embodiments, the processed sales data 145 and the sales data 112 may be pushed onto the user's device instead of the user's device requesting the data.

Network interface logic 148 may be used to connect the data processing system 115 to the Internet or network 120 to permit the users to use the sales data 112. A graphical user interface may be used to prompt the user to provide login information, passwords and other authentication information (i.e. tokens, pins, answers to personal questions, or the like), to provide the user with account information, and so on.

The users 150 and 152 may communicate amongst themselves via their respective device. In an example embodiment, the users may be broken into various tiers for example certain users may have greater privileges than other users. For example, some users may be called leaders who recruit other users to work for or under them. The leaders may guide the users that they recruited in order to help the users achieve their goals of producing or generation more sales and moving up in the company or organization they are affiliated with.

FIG. 2 is an example process that may be implemented using the system shown in FIG. 1. At step 205, the sales activity data may be received by the data processing system 115. Next at step 210, the report generation logic 137 may calculate the predetermined metrics from the sales activity data. The predetermined metrics may be sales for the month by a user or sales for this year or other metrics based on the sales data. The type or types of metrics that are calculated can be pre-specified by the leader 152 or the entity that has configured the data processing system 115. Next at step 215, the system receives a request for metrics and action items from a user device or a leader device. At step 220, the report generation logic 137 may generate a user interface to display the metrics and actions using the user interface logic 135. The generated user interface may be sent to the user devices using push notification instead of e-mail. Push technology works by providing a constantly-open IP connection to forward notification for the servers of a third party application to a mobile device. At step 230, on the user device the mobile application may display a form and content of metrics and action items that were requested. Next at step 235, the data processing system may receive a request to perform at least one action item. The action items that displayed on the leader's device are chosen based on how close a user is to achieving a goal or milestone.

In another embodiment, at step 215 the user may open a mobile application on a user device to choose a report (e.g. 10 producers). The application may generate a message for the server to request the data from the sales data 112 or the processed sales data 148. The user management logic 130 may compute the Top 10 producer metric from the processed sales data 148 on the server and generate a display of the data onto the application or user device. Moreover, the system may generate an action that can be taken by the user based on the repost such as send a message to one of the top 10 users. So the information that is received will either be stored on the mobile device (some videos, images) and other data may be stored on the database of the marketing computer system 110. All of the data will be transmitted through the data processing system 115 in each direction for security verification and/or for the data processing system 115 to make any necessary computations from the data.

In a direct marketing organization compensation plans are designed to direct behavior. The embodiments described above are designed to break that behavior down so that the user doesn't have to think because the “app” has interpreted the commands from the compensation plan into the correct, most productive and efficient behaviors. At step 220, the user interface has been built to display the computed metrics (step 210) and requested (step 215) on the device. At step 225, the push notification can be sent by two different entities. First, the company itself (“Corporate” or “Home Office”) has the ability from a back end control panel to send a message and send a “push notification” to any, all, or select mobile devices having the application. The marketing company has discretion with respect to who will receive the messages. For example, if it's a big company-wide promotion like “Sell 5 memberships by the 15th or recruit 5 new distributors by the 15th—you'll get a free iPad”, the company may select “send to all distributors”. Alternatively, the promotion may be specific to a certain level like “Executive Director” or “Someone in the Promo Club for 3 months consecutively.” Either way, when the company sends the message, they'll have a web interface control panel where the company can select who will receive a particular message. All messages will be sent to the data processing system 115 and distributed accordingly to the selected application user. Not only can the message be originated from the marketing computer system 110 but the message can be generated by the top field leaders 152. For example someone at level “ABC”, can be provided with an interface to select and send messages. If the message is sent from the application, it will go from the application to the data processing system 115 (connect with the database to verify permissions and current ABC qualifications) and then back to data processing system 115 and off to the application of the recipient as a push notification. The database may generate a message to the mobile device to send notifications if they're not qualified at ABC level to send a message.

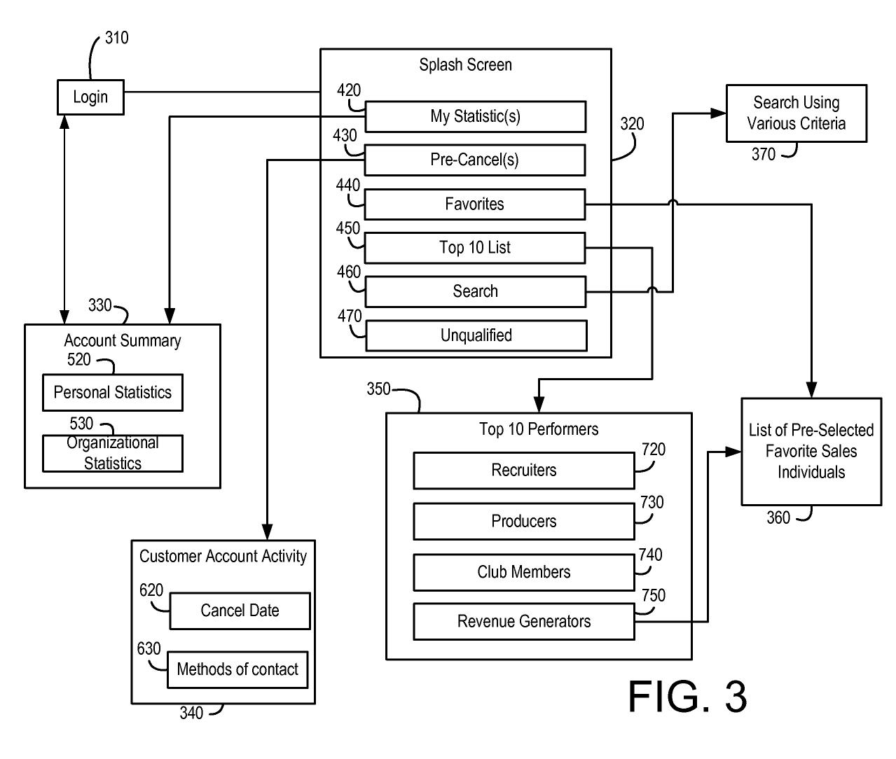

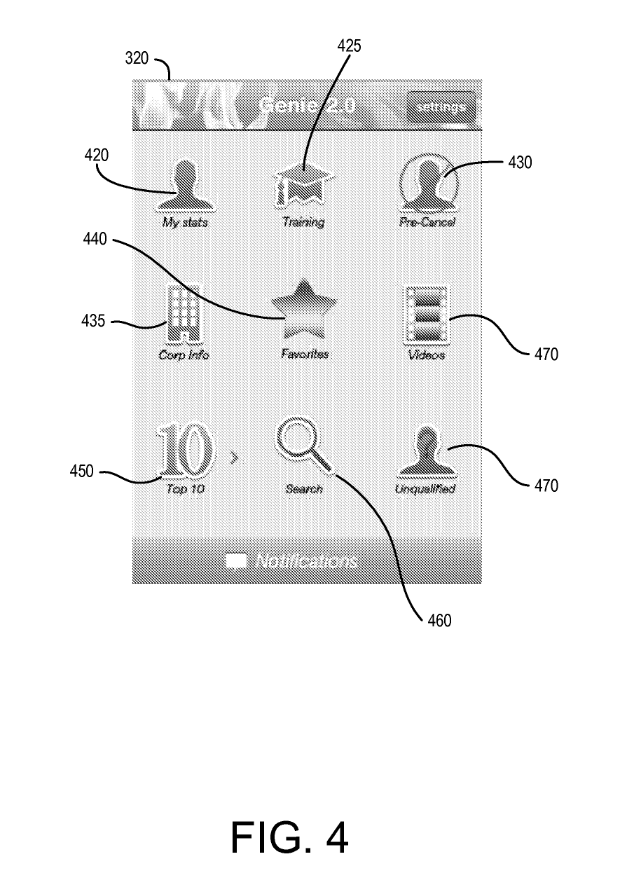

FIG. 3 is sequence of displays that may be provided to a user using the system shown in FIG. 1 to begin a network marketing management process. At step 310 user may login using authenticating credentials provided to the user from the data processing system via e-mail, mail or another form of communication. A splash screen 320 as shown in FIG. 4 is shown to the user. Alternatively, after login the user may be shown the account summary 330 based on the user settings on the mobile device. The splash screen 320 may include, among other features, allowing the user to choose the at least one of the following options, My statistic(s) 420, pre-cancel(s) 430, favorite people 440, top 10 list 450, search 460, and unqualified 470. If the user chooses the my statistic 420, then an account summary 330 is shown to the user. The account summary 330 includes the user's personal statistics 520 and the user's organizational statistics 530. The user's organizational statistics 530 may include the statistics of all individuals that were brought to the organization or introduced to the organization by the user. If on the splash screen the user chooses favorites 440, then the application retrieves from the data processing system a list of pre-selected favorite sales individuals. The user may be provided with the ability to change the list of favorite sales individuals. If the user selects the top 10 list 450, then the system generates the top 10 performers 350. In one embodiment, the top 10 performers include the top 10 recruiters 720, producers 730, club members 740, and revenue generators 750. The top 10 list 450 is different for each individual because they are users selected from the users that are being supervised by the user. Alternatively, the user may choose pre-cancel 430 option, where the customer account activity 340 is retrieved. The customer account activity includes the cancel date 620 and the methods of contacting the customer 630. The splash screen also offers the user the choice to choosing to perform a search using various criteria. The user may also choose to review the unqualified users 470 in order to qualify the other users.

FIG. 4 is a customizable display showing various options that may be presented to a user. As discussed above the splash screen from FIG. 4 may be shown to the user. The splash screen 320 includes, but is not limited to, my stats 420, training 425, pre-cancel 430, corporate information 435, favorites 440, video 470, top 10 450, search 460, and unqualified 470. In FIG. 4, when the user selects the top 10 option, the data processing system 115 may search the database for the table entitled “sales” for MTD (month to date) or within that marketing company's cycle (which maybe a revolving 30 days not necessarily calendar). If the company has sales (value of all good sold for the period by that distributor) than we compute the top person by who has the highest dollar amount in that period of time. If the marketing company doesn't display sales dollars, but simply sales # (meaning the NUMBER of sales versus the $VALUE of all sales), than we rank by quantity sold.

The server will scour the database for the table entitled “recruits” or “new distributors” or whatever the company calls the table. This table is the one that displays a # of how many new people the person hired/brought in/recruited for the MTD (month to date) or period of time they use. If the company has one table outlining this number than the server will compute the largest number and make that person Rank #1 then displayed #2, 3 . . . as follows. Some companies have two tables for this. For example Pre-Paid Legal has one table called “Sponsored” and another called “Placed” which basically is the same thing but listed differently depending on if you put the new recruit directly underneath you (aka “Frontline”) vs. placing the recruit in depth under another distributor in the downline. In that case, we simply add the 2 tables together to get a full number. Then we compare the sum to all the other sums and display the top #1 recruiter as the person with the highest sum, and so forth on to the next person #2, and so on.

Again, this differs from company to company but it's all relatively the same thing. Most of these metrics are based upon a pre-determined parameter or benchmark that the company has designed. That number may be 10 or that number may be 5 or it may be 100. It's a combination of (a) personal recruits, (b) personal sales, c) new sales from brand new personal recruits, and sometimes d) team recruits, e) team sales (also known as team volume). Displays the highest promo club people (purely for recognition purposes, so we can call the top people and verbally congratulate them and applaud them)—which is simply by displaying the top point earners and so forth and (2) we display the people who are close to the rank. If the company sets the “benchmark at X” than we list people who are X-1 first, then X-2, then X-3 until we have listed 10 people. Because there is something to gain (or avoid losing) by getting those last few points and they are easy to motivate because they are so close.

The database is queried for a table that shows expiration dates of credit cards coming up (passive cancellation) and auto-shipments/memberships that have been marked “cancelled” (active cancellation) but have a few days left or a few weeks, months left until their last shipment of goods or service ends. We then pool the database listing the most recent passive cancellation first (up to 10 in order from most recent passive to least recent passive) then we list the active cancellations in the same list after the passive ones (from most recent active cancels to least recent active cancellations).

Unqualified may be determined based on a few factors (1) a new person selling their first piece of merchandise/product/service-plan, (2) a new person recruiting their first # of distributors, (3) a possible license, (4) a potential class they must take, (5) and a time limit. We scour the database under this person's name for this information. We then display the non-promoted new people on this page with all the data below their name, visually. We display everything in gray until it gets complete. So if this company requires XXXYYZ to rank up, we display the X's Y's and Z's in gray-ed out with a green process-bar-line depicting the time left. Longer lines are green and mean more time. Shorter lines are yellow and mean less time. Shortest lines are RED and mean time is almost up! When the new person sells/completes an X or Y or Z, we change the color from gray to some color that we've decided on that looks nice. This will show the upline distributor looking at this report, instantly, how much left is to be done. The color bar line (progress bar) will move according to the calendar date they have to hit their promotion. There are three buttons at the top which can list the top 10 new unpaid top distributors in three user-selected fashions. (1) Days left—this will rank the new unpaids according to who has the fewest days left RED to most days left GREEN, in that order. (2) Completeness—this will rank the new unpaids according to who has the most work left to do from LEAST work left to MOST work left, in that order. The metric here is based upon the XXXYYZ. We will weight the difficulty of X, Y and Z results so that it's not just a total number left. (if Z is 10 times harder to do that X, someone with Z left only may be ranked below someone who has XXX left. (3) Alphabetical. Default will be Days Left. Note: There will be a second area for listing new people by the date they came in. That will be the only parameter upon which displaying will use rank. Most recent joiners then so on and so forth. That way all new people will pop up on the device and we can call and welcome them.

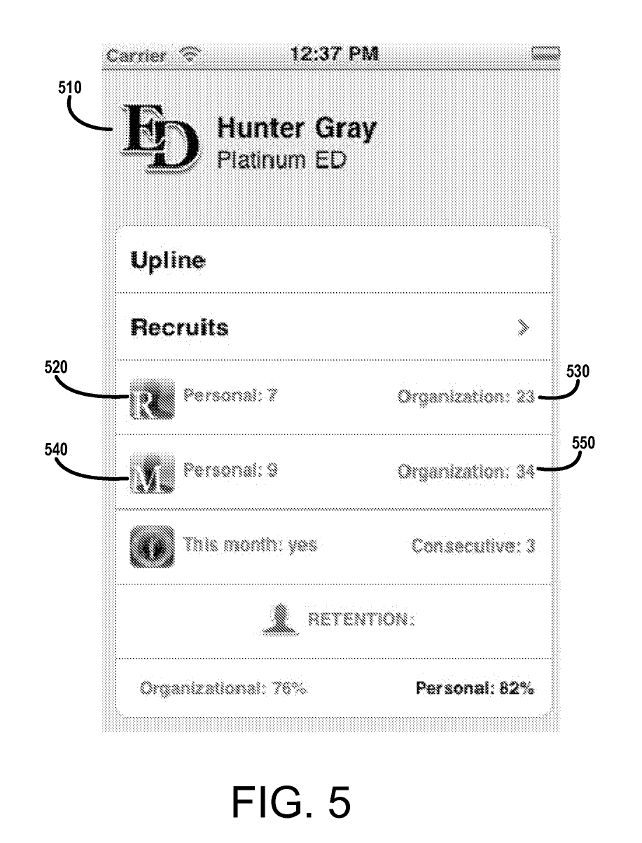

FIG. 5 is a screen display showing account statistics for an example user (i.e. Hunter Fray). Label 510 show the rank of the distributor in the marketing company's compensation plan. For example, ED could represent an executive director. Personal 520 represents the number of unique recruits for the month that were brought in by the example user. Organization 530 represents the number of individuals that are part of the user's team. Sale volume sold to date is shown by personal 540 and the organization sales as 550.

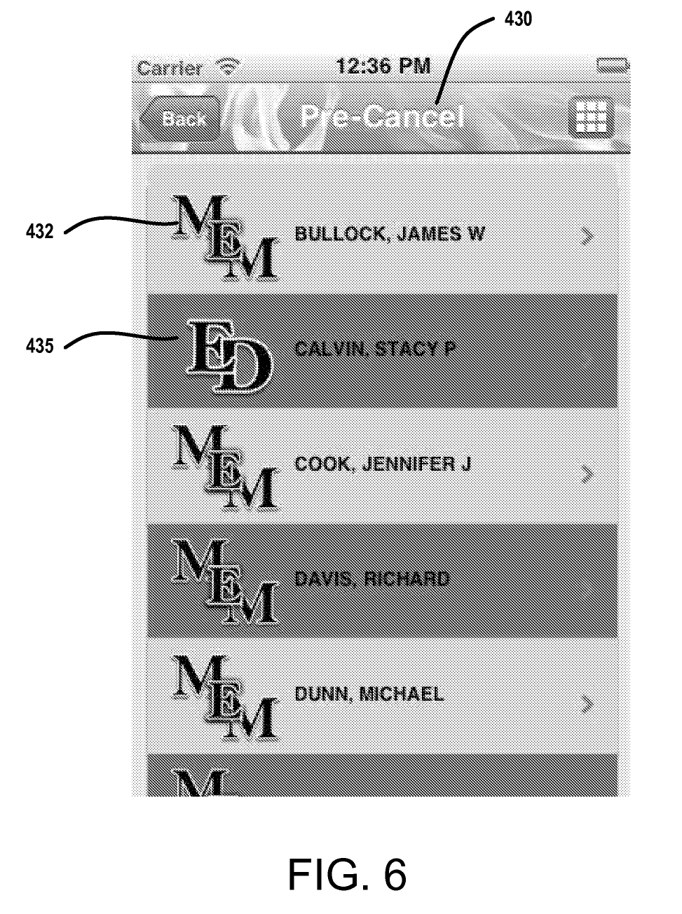

FIG. 6 is a screen display showing a listing of other users who may be about to cancel a service or a subscription. Example distributors 432 or 435 have submitted a request to cancel and thus their information is shown in the pre-cancel screen 430. Various situations lead to a user's name showing on the pre-cancel screen, such as but not limited to, when a user's credit card is going to expire, the last payment was not processed, or the last payment funds were not receive.

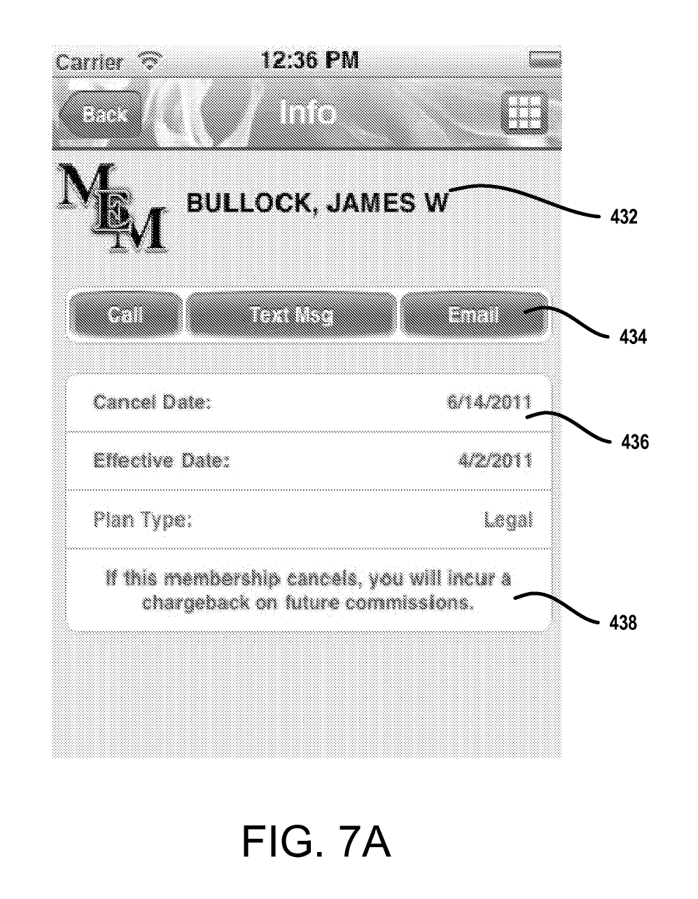

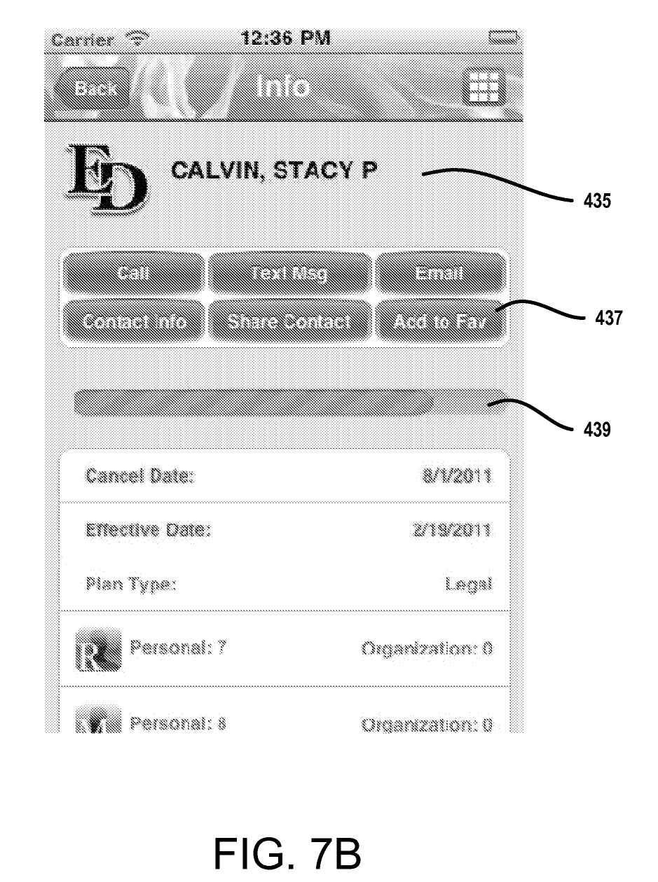

FIG. 7A is a screen display showing information regarding one of the users listed in FIG. 6. Line 434 displays buttons like call, text message or e-mail that allows a leader to contact the user to remedy the pre-cancel status. Cancel date 436 is determined based on the date on which the distributor will be cancelled. In one embodiment, the system may determine the amount of chargeback or future commission that the leader may be charged based on the most recent payments to the pre-cancel user and display that in text box 438 with a warning.

FIG. 7B is a screen display showing information regarding another user from FIG. 6. Button 437 allows a user to add a distributor to the favorites list. Progress bar 439 visually shows the leader how close the user 435 may be to their next goal. Accordingly, if the user 435 is very close to the goal and they are about to cancel, then a motivation message may be generated and sent to the user 435, that informs the user that they are near a goal.

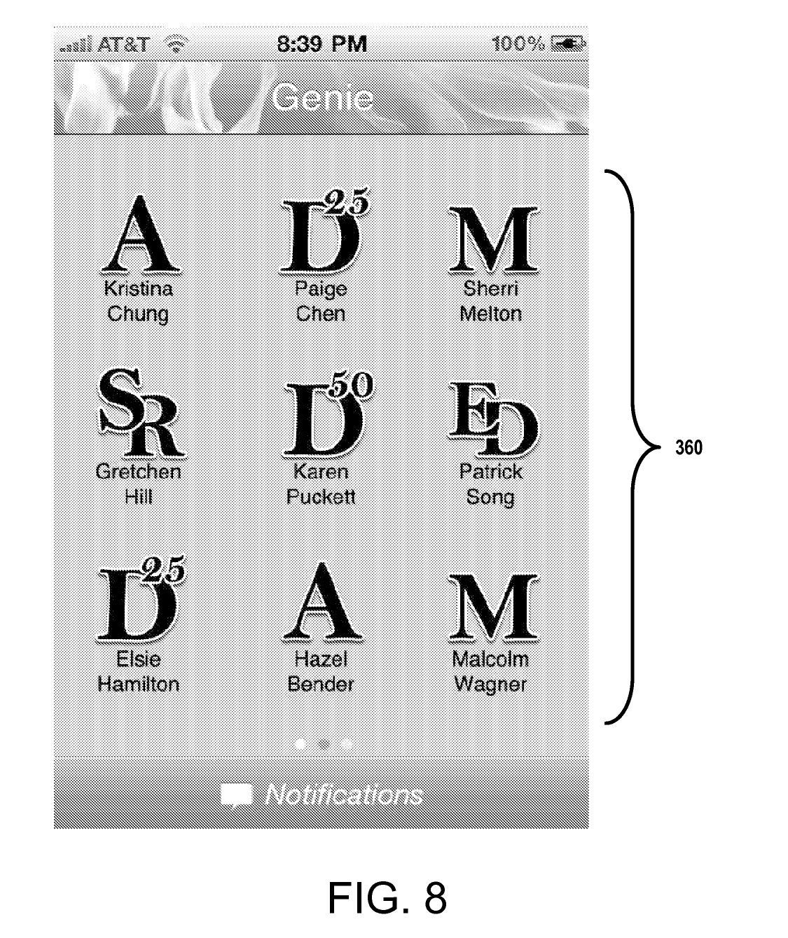

FIG. 8 is a screen display screen 360 display showing a listing of other users that have been selected as favorite users. In one embodiment, the user's rank may be shown as a graphic. In another embodiment, the user's image may be shown depending on the user preferences. The rank may be displayed a set of letter and combined with numbers may indicate a user's rank.

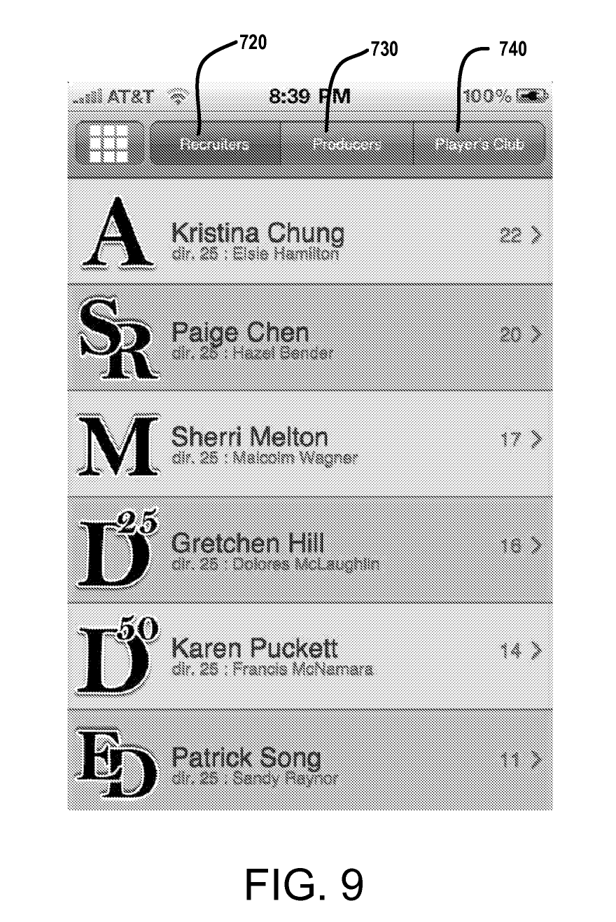

FIG. 9 displays predetermined reports that shows the top performs by recruiters 720, producers 730, and player's club 740. In one embodiment, the display shown in FIG. 9 also displays the distributor who are more than 80% done with one or more goals. Displaying this allows the leader who is viewing the screen to let the user know that they are almost done with their goal.

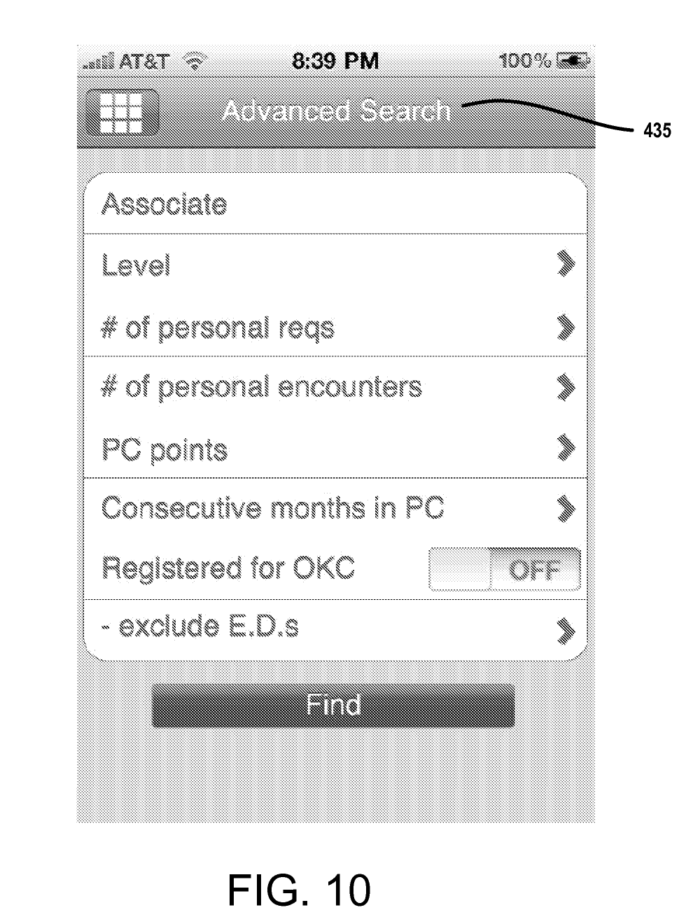

FIG. 10 is a screen display that may be provided to a users to allow the user to perform a search based on various criteria. The advance search option includes searching by level, number of requests, number of encounters, club points or consecutive club points.

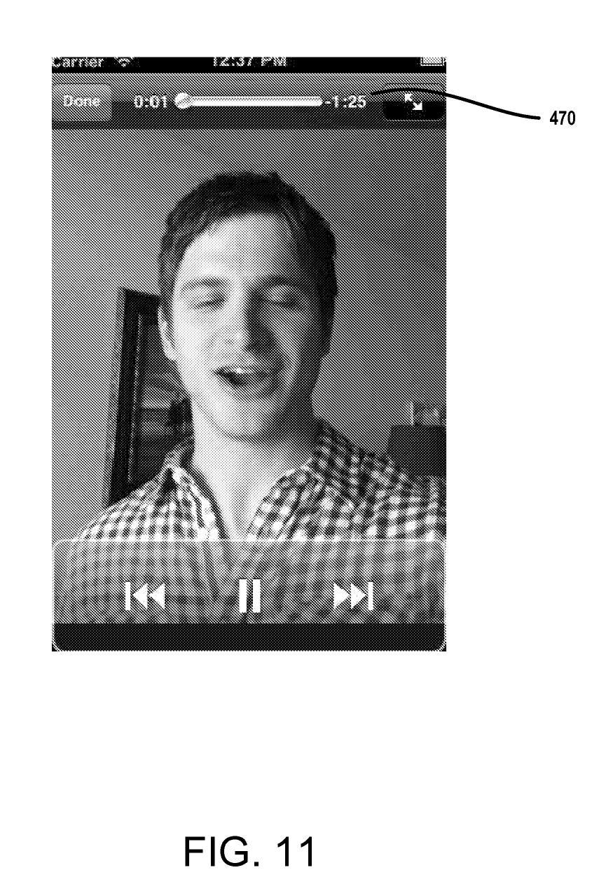

FIG. 11 is screen display that may be provided to an account holder that shows the account holder a video that was recorded by the account holder. The video was recorded initially in response to the user being asked a question. The question could be why the user wanted be a distributor or what are the user's goals. Embodiments are directed to a system of thinking for sales organization. The system delivers key data in a visual and actionable format, the sellers and their leadership are empowered to perform the most relevant high payoff activities with information they need to be more efficient and productive. The system also combines these features with a marketing and sales tools such as presentations, videos, CRM, shopping, social media and sign up capabilities. All elements are available in any combination. A system of thinking expressed in the form of a mobile software application stored on a non-transitory storage medium. This system of thinking works on the idea that while on-the-go, direct sellers need a tool that will help them. Take the most effective actions possible in the shortest period of time by, delivering key performance indicators in an actionable format, knowing which information to display and more importantly which information not to display, displaying information in a visual format to allow faster assimilation, eliminating confusion which is an epidemic in the industry, actively notifying sellers of vital information and suggesting pertinent action which can be taken in one touch or click.

The system allows the user to record video of users telling themselves why they will commit to their outcome strategy for playback and push reminders at a later, less committed time. The system includes the ability to ‘see as’ another person allows an upline user to see the downline's organization as if it were his/her own view. The method focuses on easy access to high retention activity, fast track favorites of people whom are important to work closely with who may normally slip through the cracks because it's hard to follow up with many people. The system allows a user to become more effective sellers by providing digital versions of their sales tools for display on the device. The device may store information such as but not limited to a slide show, video, graphs, diagrams, brochures, CRM (Client Relations Management) tools. The system allows the user to input new prospects, receive new prospects from an outside source, track potential sales leads, track potential recruits, remind sellers to follow up with leads based on priority, time passed and other factors and deliver this information in an actionable format. The best way to use the system is to allow the system access to the database of a network marketing company and allow that company's distributors to take advantage of it's features. For new distributors the system will eliminate confusion by displaying information on the details such as but not limited to, compensation plan, why video (emotional hook to business commitment), training videos, current incentives, various rank levels and how to achieve them, contact information for corporate, field, and product support.

Features include but are not limited to the following:

Reports deliver distributors the vital statistics about their team in an actionable format, on the go. Personal statistics: Personal counters, recruits, bonus points, etc. Plus current progress towards next promotion and a clear indication of what needs to happen to get there.

Custom search: Sift through any team in your organization with an advanced search function. Search by a combination of criteria such as level, rank, location, etc. Touch to contact, Touch to call, email or text any member of your team or up line. Push notifications can eliminate communications lag time and instantly notify the field of vital information and active bonuses. Customer tracking to see a list of active customers with membership/autoships in place. Follow up. Check on Pre-Cancels, up sell, recruit, etc. Company information can include a compensation plan, current bonuses and incentives. Favorites can include selecting anyone on your team and track their activity and progress.

The embodiments discussed above have been described with reference to drawings. The drawings illustrate certain details of specific embodiments that implement the systems and methods and programs. However, describing the embodiments with drawings should not be construed as imposing any limitations that may be present in the drawings. The embodiments contemplate methods, systems and program products on any machine-readable media for accomplishing its operations. The machine-readable media can be non-transitory machine readable storage media. The embodiments may be implemented using an existing computer processor, or by a special purpose computer processor incorporated for this or another purpose or by a hardwired system.

As noted above, embodiments include program products comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise non-transitory machine readable media, RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the embodiments might include a general purpose computing computers in the form of computers, including a processing unit, a system memory or database, and a system bus that couples various system components including the system memory to the processing unit. A user computing device may be desktop computer, laptop computer, mobile computing device (e.g., handheld e-mail device, cellular phone, etc. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the embodiments. Such variations will depend on the software and hardware systems chosen and on designer choice. It is understood that all such variations are within the scope of the embodiments. Likewise, software and web implementations of the embodiments could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the embodiment to the precise form disclosed, and modifications and variations are possible in light of the above teachings or may be acquired from practice of the embodiment. The embodiments were chosen and described in order to explain the principals of the concepts and its practical application to enable one skilled in the art to utilize the various embodiments and with various modifications as are suited to the particular use contemplated. Other substitutions, modifications, changes and omissions may be made in the design, operating conditions and arrangement of the embodiments.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The subject matter discussed above is not limited to a particular embodiment, but extends to various modifications, combinations, and permutations that nevertheless fall within the scope and spirit of the appended claims.

What is claimed is:

1. A method, comprising:
receiving sales activity data from a plurality of users;
calculating metrics based on the sales activity data, the metrics including an indication that a first user's sales numbers are greater than fifty percent of a predetermined goal;
generating a message to be sent to a second user, the message configured to inform the second user regarding the progress of the first user's sales activities;
the message comprises a link that is selectable by the second user to send a message to the first user.

2. The method according to claim 1, wherein the message includes informing the first user of their progress towards the goal and the message is configured to include another message by the second user.

3. The method according to claim 1, further comprising generating a list of actions that the first user can take in order to the predetermined goal.

4. The method according to claim 3, further comprising allowing the first user to indicate the chosen action and performing the chosen action on a server and sending a message back to the second user.

5. The method according to claim 4, wherein after receiving the choice by the first user, informing the second user regarding the option selected by the first user.

6. The method according to claim 4, further comprising generating a report that is configured to display a list of users that have been scheduled to be cancelled.

7. A non-transitory computer readable medium storing computer program product, which, when executed by a computer, causes the computer to perform steps comprising:
receiving sales activity data from a plurality of users;
calculating metrics based on the sales activity data, the metrics including an indication that a first user's sales numbers are greater than fifty percent of a predetermined goal;
generating a message to be sent to a second user, the message configured to inform the second user regarding the progress of the first user's sales activities;
the message comprises a link that is selectable by the second user to send a message to the first user.

8. The non-transitory computer readable medium according to claim 7, wherein the message includes informing the first user of their progress towards the goal and the message is configured to include another message by the second user.

9. The non-transitory computer readable medium according to claim 7, further comprising generating a list of actions that the first user can take in order to achieve the predetermined goal.

10. The non-transitory computer readable medium according to claim 9, further comprising allowing the first user to indicate the chosen action and performing the chosen action on a server and sending a message back to the second user.

11. The non-transitory computer readable medium according to claim 10, wherein after receiving the choice by the first user, information the second user regarding the option selected by the first user.

12. The non-transitory computer readable medium according to claim 7, further comprising generating a report that is configured to display a list of users that have been scheduled to be cancelled.

13. An apparatus, comprising:
a sales database configured to receive sales activity data from a plurality of users;
a report generation logic configured to calculate metrics based on the sales activity data, the metrics including an indication that a first user's sales numbers are greater than fifty percent of a predetermined goal;
a user interface generation logic configured to generate a message to be sent to a second user, the message configured to inform the second user regarding the progress of the first user's sales activities;
wherein the message comprises a link that is selectable by the second user to send a message to the first user.

14. The apparatus according to claim 13, wherein the message includes informing the first user of their progress towards the goal and the message is configured to include another message by the second user.

15. The apparatus according to claim 13, wherein the report configuration logic is configured to generate a list of actions that the first user can take in order to achieve the predetermined goal.

16. The apparatus according to claim 15, further comprising allowing the first user to indicate the chosen action and performing the chosen action on a server and sending a message back to the second user.

17. The apparatus according to claim 15, wherein after receiving the choice by the first user, informing the second user regarding the option selected by the first user.

18. The apparatus according to claim 13, further comprising generating a report that is configured to display a list of users that have been scheduled to be cancelled and allowing the second user to contact the list of users that have been scheduled to be cancelled.
